(19) United States
(12) Patent Application Publication
(10) Pub. No.: US 2024/0086952 A1
(43) Pub. Date: Mar. 14, 2024

(54) MOBILITY DATA-BASED END USER FILTERING SYSTEM

(71) Applicants: CoreLogic Solutions, LLC, Irvine, CA (US); El Toro.com LLC, Louisville, KY (US)

(72) Inventors: Brian Battaglia, Southlake, TX (US); Heidi Russell, Waynesboro, PA (US); Praveen Chandramohan, San Diego, CA (US); Rohnak Habeeb, Bonney Lake, WA (US); Heather Burch, Plainfield, IL (US); Richard Teachout, Louisville, KY (US); Stacy Griggs, Louisville, KY (US); William McConnell, Louisville, KY (US); Rorie Lizenby, New Albany, IN (US)

(21) Appl. No.: 18/465,092

(22) Filed: Sep. 11, 2023

Related U.S. Application Data
(60) Provisional application No. 63/405,755, filed on Sep. 12, 2022.

(51) Int. Cl. G06Q 30/0204; G06Q 50/16; H04W 4/029

(52) U.S. Cl. CPC G06Q 30/0205; G06Q 50/16; H04W 4/029

(57) ABSTRACT

An improved computing system can use mobility data corresponding to a particular mobile device to identify one or more geographic locations to which the mobile device traveled within a certain period of time. The computing system can use parcel data to identify parcels that are located at any one of the identified geographic locations. The computing system can further use the parcel data to identify a subset of the identified parcels that are listed for sale or rent. If the computing system identifies at least one parcel that the mobile device visited that is available on the market, this may indicate that the user who operates the mobile device may be shopping for a home. In response, the computing system can update information about the user to indicate that the user may be shopping for a home.

### CROSS-REFERENCE TO RELATED APPLICATIONS

This application claims the benefit of priority to U.S. Provisional Application No. 63/405,755, entitled “USER INTERFACE FOR IDENTIFYING SPECIFIC INDIVIDUALS” and filed on Sep. 12, 2022, which is hereby incorporated by reference herein in its entirety.

### TECHNICAL FIELD

The present disclosure generally relates to using user device mobility data and parcel data to identify end users that exhibit a specific type of behavior and surfacing the results in a user interface.

### BACKGROUND

User devices can include mobile devices, such as mobile phones, watches, tablets, laptops, tracking devices, etc. Generally, such mobile devices include global positioning system (GPS) or other location monitoring capabilities that allow the mobile devices to identify the geographic location within which the respective mobile device is located. In addition, the geographic location of those mobile devices that have wireless transceivers (e.g., cellular transceivers, IEEE 802.11 transceivers, etc.) can be identified based on signals transmitted to and/or from wireless infrastructure (e.g., cellular towers, other cellular infrastructure, satellites, IEEE 802.11 wireless routers, etc.). Thus, the mobile devices themselves or other infrastructure with which the mobile devices communicate can track the geographic location of the mobile devices over time.

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a system for identifying an end user that exhibits a type of behavior, the system comprising memory that stores computer-executable instructions. The system further comprises a processor in communication with the memory, where the computer-executable instructions, when executed by the processor, cause the processor to: obtain an identification of a first plurality of parcels managed by a service user; determine, using mobility data, a first end user device that is associated with a first parcel in the first plurality of parcels; determine, using the mobility data, a second plurality of parcels visited by the first end user device; identify a subset of the second plurality of parcels that each comprise a characteristic that corresponds with the type of behavior; and cause information related to a first end user of the first end user device to be updated based on the identification of the subset of the second plurality of parcels.

The system of the preceding paragraph can include any sub-combination of the following features: where the computer-executable instructions, when executed, further cause the processor to: obtain supplemental data that identifies an action performed by the first end user that corresponds with the type of behavior, and cause information related to a first end user of the first end user device to be updated based on the identification of the subset of the second plurality of parcels and reception of the supplemental data that identifies the action performed by the first end user that corresponds with the type of behavior; where the computer-executable instructions, when executed, further cause the processor to provide at least one of the mobility data associated with the first end user device or parcel data as an input to a trained artificial intelligence model, where providing at least one of the mobility data associated with the first end user device or the parcel data as the input to the trained artificial intelligence model causes the trained artificial intelligence model to output a propensity score that represents a likelihood that the first end user is engaging in an action that corresponds with the type of behavior; where the computer-executable instructions, when executed, further cause the processor to cause the information related to the first end user of the first end user device to be updated with the propensity score; where the computer-executable instructions, when executed, further cause the processor to mask personally identifiable information comprised within the mobility data; the computer-executable instructions, when executed, further cause the processor to: generate user interface data that, when processed by a user device, causes the user device to render and display a user interface, where the user interface depicts the information related to the first end user and a geographic map identifying a location of the first parcel, and transmit the user interface data to the user device; where the user interface further comprises a filter, where selection of the filter causes the user interface to display the information related to the first end user in response to a determination that the first end user satisfies a criterion of the filter; where the filter comprises one of a geography filter, a new end user filter, a low-to-moderate (LMI) income filter, an end user behavior filter, a contact status filter, or a service user team member assignment filter; where the computer-executable instructions, when executed, further cause the processor to cause the information related to the first end user to be updated periodically; where the computer-executable instructions, when executed, further cause the processor to transmit the information related to the first end user in response to an application programming interface (API) call; where the computer-executable instructions, when executed, further cause the processor to include the information related to the first end user in a customer relationship management (CRM) file owned by the service user; where the computer-executable instructions, when executed, further cause the processor to cause the first end user device to display a digital advertisement that describes a service offered by the service user; where the first end user is an existing customer of the service user; where the computer-executable instructions, when executed, further cause the processor to: determine that the first end user device traveled to a first geographic location based on the mobility data, determine based on the mobility data that the first end user device spent more time at the first geographic location than any other geographic location during a first time period, determine that the first parcel is located at the first geographic location, and map the first end user device to the first parcel; and where the characteristic comprises an availability for purchase or rent.

Another aspect of the disclosure provides a computer-implemented method for identifying an end user that exhibits a type of behavior. The computer-implemented method comprises: obtaining an identification of a first plurality of parcels managed by a service user; determining, using mobility data, a first end user device that is associated with a first parcel in the first plurality of parcels; determining, using the mobility data, a second plurality of parcels visited by the first end user device; identifying a subset of the second plurality of parcels that each comprise a characteristic that corresponds with the type of behavior; and causing information related to a first end user of the first end user device to be updated based on the identification of the subset of the second plurality of parcels.

The computer-implemented method of the preceding paragraph can include any sub-combination of the following features: where the computer-implemented method further comprises providing at least one of the mobility data associated with the first end user device or parcel data as an input to a trained artificial intelligence model, where providing at least one of the mobility data associated with the first end user device or the parcel data as the input to the trained artificial intelligence model causes the trained artificial intelligence model to output a propensity score that represents a likelihood that the first end user is engaging in an action that corresponds with the type of behavior; where the computer-implemented method further comprises generating user interface data that, when processed by a user device, causes the user device to render and display a user interface, where the user interface depicts the information related to the first end user and a geographic map identifying a location of the first parcel, and transmitting the user interface data to the user device; and where the user interface further comprises a filter, where selection of the filter causes the user interface to display the information related to the first end user in response to a determination that the first end user satisfies a criterion of the filter.

Another aspect of the disclosure provides a non-transitory, computer-readable medium comprising computer-executable instructions for identifying an end user that exhibits a type of behavior, where the computer-executable instructions, when executed by a computer system, cause the computer system to: obtain an identification of a first plurality of parcels managed by a service user; determine, using mobility data, a first end user device that is associated with a first parcel in the first plurality of parcels; determine, using the mobility data, a second plurality of parcels visited by the first end user device; identify a subset of the second plurality of parcels that each comprise a characteristic that corresponds with the type of behavior; and cause information related to a first end user of the first end user device to be updated based on the identification of the subset of the second plurality of parcels.

Another aspect of the disclosure provides system for identifying an end user that exhibits a type of behavior. The system comprises memory that stores computer-executable instructions. The system further comprises a processor in communication with the memory, where the computer-executable instructions, when executed by the processor, cause the processor to: obtain an identification of a first plurality of parcels managed by a service user; obtain an indication that a first end user device that is associated with a first parcel in the first plurality of parcels visited a second plurality of parcels; identify a subset of the second plurality of parcels that each comprise a characteristic that corresponds with the type of behavior; and cause information related to a first end user of the first end user device to be surfaced to the service user based on the identification of the subset of the second plurality of parcels.

The system of the preceding paragraph can include any sub-combination of the following features: where the computer-executable instructions, when executed, further cause the processor to: generate user interface data that, when processed by a user device, causes the user device to render and display a user interface, where the user interface depicts the information related to the first end user and a geographic map identifying a location of the first parcel, and transmit the user interface data to the user device; where the user interface further comprises a filter, where selection of the filter causes the user interface to display the information related to the first end user in response to a determination that the first end user satisfies a criterion of the filter; where the filter comprises one of a geography filter, a new end user filter, a low-to-moderate (LMI) income filter, an end user behavior filter, a contact status filter, or a service user team member assignment filter; where the computer-executable instructions, when executed, further cause the processor to include the information related to the first end user in a customer relationship management (CRM) file owned by the service user; where the computer-executable instructions, when executed, further cause the processor to obtain a customer relationship management (CRM) file that comprises the identification of the first plurality or parcels via a network page; and where the characteristic comprises an availability for purchase or rent.

Another aspect of the disclosure provides a computer-implemented method for identifying an end user that exhibits a type of behavior. The computer-implemented method comprises: obtaining an identification of a first plurality of parcels managed by a service user; obtaining an indication that a first end user device that is associated with a first parcel in the first plurality of parcels visited a second plurality of parcels; identifying a subset of the second plurality of parcels that each comprise a characteristic that corresponds with the type of behavior; and causing information related to a first end user of the first end user device to be surfaced to the service user based on the identification of the subset of the second plurality of parcels.

The computer-implemented method of the preceding paragraph can include any sub-combination of the following features: where causing information related to a first end user of the first end user device to be surfaced to the service user further comprises: generating user interface data that, when processed by a user device, causes the user device to render and display a user interface, where the user interface depicts the information related to the first end user and a geographic map identifying a location of the first parcel, and transmitting the user interface data to the user device; where the user interface further comprises a filter, where selection of the filter causes the user interface to display the information related to the first end user in response to a determination that the first end user satisfies a criterion of the filter; where the filter comprises one of a geography filter, a new end user filter, a low-to-moderate (LMI) income filter, an end user behavior filter, a contact status filter, or a service user team member assignment filter; where causing information related to a first end user of the first end user device to be surfaced to the service user further comprises including the information related to the first end user in a customer relationship management (CRM) file owned by the service user; where obtaining an identification of a first plurality of parcels further comprises obtaining a customer relationship management (CRM) file that comprises the identification of the first plurality or parcels via a network page; and where the characteristic comprises an availability for purchase or rent.

Another aspect of the disclosure provides a non-transitory, computer-readable medium comprising computer-executable instructions for identifying an end user that exhibits a type of behavior, where the computer-executable instructions, when executed by a computer system, cause the computer system to: obtain an identification of a first plurality of parcels managed by a service user; obtain an indication that a first end user device that is associated with a first parcel in the first plurality of parcels visited a second plurality of parcels; identify a subset of the second plurality of parcels that each comprise a characteristic that corresponds with the type of behavior; and cause information related to a first end user of the first end user device to be surfaced to the service user based on the identification of the subset of the second plurality of parcels.

The non-transitory, computer-readable medium of the preceding paragraph can include any sub-combination of the following features: where the computer-executable instructions, when executed, further cause the computer system to: generate user interface data that, when processed by a user device, causes the user device to render and display a user interface, where the user interface depicts the information related to the first end user and a geographic map identifying a location of the first parcel, and transmit the user interface data to the user device; where the user interface further comprises a filter, where selection of the filter causes the user interface to display the information related to the first end user in response to a determination that the first end user satisfies a criterion of the filter; where the filter comprises one of a geography filter, a new end user filter, a low-to-moderate (LMI) income filter, an end user behavior filter, a contact status filter, or a service user team member assignment filter; where the computer-executable instructions, when executed, further cause the computer system to include the information related to the first end user in a customer relationship management (CRM) file owned by the service user; and where the computer-executable instructions, when executed, further cause the computer system to obtain a customer relationship management (CRM) file that comprises the identification of the first plurality or parcels via a network page.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of an illustrative operating environment in which a user identification system and a user device mapping system use mobility data and/or parcel data to filter end users and identify those end users who may be interested in a specific type of product or service.

FIG. 2 is a flow diagram illustrating the operations performed by the components of the operating environment of FIG. 1 to identify geographic locations visited by end user devices.

FIG. 3 is a flow diagram illustrating the operations performed by the components of the operating environment of FIG. 1 to identify end users exhibiting actionable behavior.

FIG. 4 is another flow diagram illustrating the operations performed by the components of the operating environment of FIG. 1 to identify end users exhibiting actionable behavior.

FIG. 5 illustrates an example user interface that depicts information about end users associated with a service user and that exhibit behavior that indicates that the end users may be interested in a service or product offered by the service user.

FIG. 6 is a flow diagram depicting an example end user identification routine illustratively implemented by a user identification system and/or a user device mapping system, according to one embodiment.

FIG. 7 is another flow diagram depicting an example end user identification routine illustratively implemented by a user identification system, according to one embodiment.

### DETAILED DESCRIPTION OF SPECIFIC EMBODIMENTS

As described above, mobile devices themselves or other infrastructure with which the mobile devices communicate can track the geographic location of mobile devices over time. Tracking the geographic location of mobile devices can be useful for a variety of applications. For example, tracking the geographic location of a mobile device over time can be used to identify a geographic location at which the mobile device is most often present. The identified geographic location may represent a place where a user of the mobile device resides (where a user of a mobile device is also referred to herein as an “end user”). As another example, tracking the geographic location of a mobile device over time can be used to identify other locations of interest at which the mobile device is often present. Such locations of interest can include a place at which the user of the mobile device works, a school that the user of the mobile device attends, a store at which the user of the mobile device shops, and/or the like.

Generally, it can be difficult for existing computing systems to accurately identify specific individuals that may be interested in advertisements, services, or other materials related to the purchase of a home. For example, existing systems may lack data that would enable the system to identify relationships or patterns between individuals that may be interested in the materials described above and those that would not be interested.

The technical deficiencies of existing computing systems could be overcome, in part, by using the mobile device tracking technology described above. For example, tracking a mobile device could indicate when an individual visits a residential area. While tracking the geographic location of mobile devices used by various individuals may provide some information about locations that various individuals frequent, the location information by itself may be insufficient in accurately identifying specific individuals that may be interested in the materials noted above. In particular, the location information may indicate that an individual visited one or more residential areas, but the location information may not indicate the significance or purpose of the visits (e.g., social, business, or actually home shopping).

The technical deficiencies of existing computing systems can be addressed, however, through the use of mobility data (e.g., data that identifies the geographic location of mobile devices over time) and/or parcel data (e.g., data that identifies the physical address and/or geographic location of parcels or properties, data that identifies parcels or properties that are listed for sale or rent, etc.). For example, an improved computing system, such as the user device mapping system described herein, could use the mobility data corresponding to a particular mobile device to identify one or more geographic locations to which the mobile device traveled within a certain period of time. Optionally, the user device mapping system may limit the identification to those geographic locations at which the mobile device remained for at least a threshold period of time (e.g., 10 minutes, 15 minutes, 1 hour, etc.) and/or at which the mobile device visited on at least two or more separate occasions (e.g., where a separate occasion may include visits that are at least a threshold time period apart, such as 6 hours, 1 day, 1 week, etc.). The user device mapping system can use the parcel data to identify parcels that are located at any one of the identified geographic locations. The user device mapping system can further use the parcel data to identify a subset of the identified parcels that are listed for sale or rent (or are otherwise available on the market).

If the user device mapping system identifies at least one parcel or property that the mobile device visited for at least a threshold time period and/or on at least two or more separate occasions and that is available on the market, this may indicate that the user who operates the mobile device may be shopping for a home. In response, the user device mapping system can update a data store that stores contact information for various end users. Alternatively or in addition, another improved computing system, such as the user identification system described herein, can update the data store that stores contact information for various end users and/or cause a user interface to be displayed on a user device that graphically depicts information about end users who have been identified as shopping for a home.

Not only can it be difficult for existing computing systems to accurately identify specific individuals that may be interested in advertisements, services, or other materials related to the purchase of a home, it can also be difficult to display information about such individuals within a single view. For example, user interfaces produced by existing systems may lack features that allow a user to view, within a single window, different types of filters to narrow the number of individuals for which information is provided, a global summary of individuals that satisfy the selected filters by geographic region (e.g., parcel, city, county, state, etc.), and/or the like. Thus, user interfaces produced by existing systems may involve the user opening multiple tabs and/or windows to view the same information, thereby increasing the number of navigational steps that a user may have to take.

The user identification system described herein, however, can use unique identifiers associated with one or more parcels and linked to user location data to make these identifications and can organize data in a way such that information relevant to a user can be displayed within a single view. Thus, the user identification system described herein provides a more accurate identification system and a more user-friendly user interface as compared to existing computing systems.

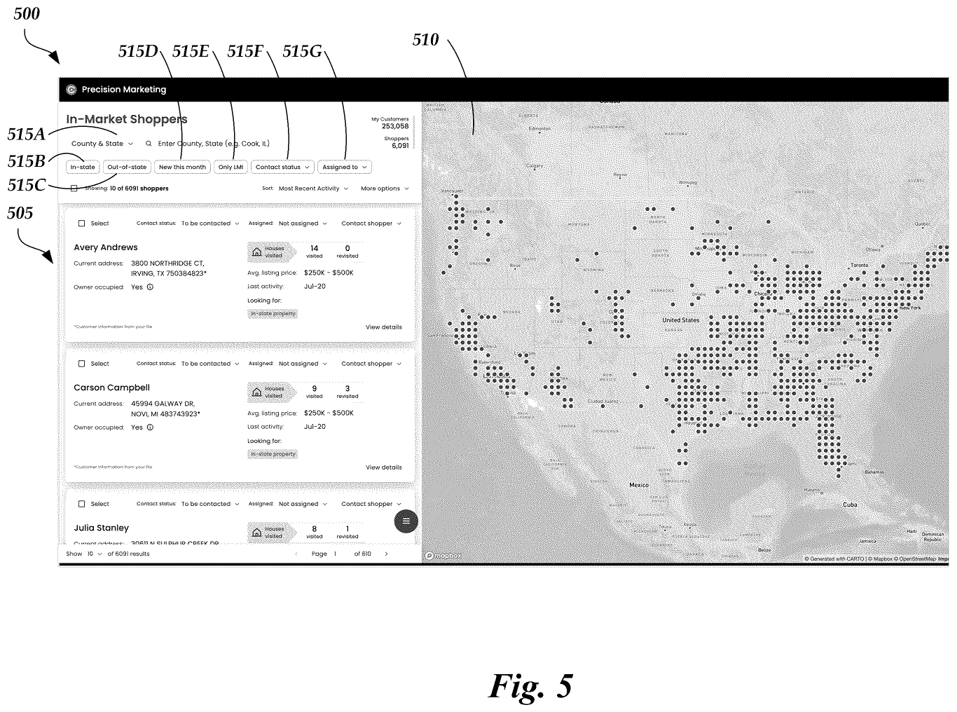

The user identification system described herein can use outputs produced by the user device mapping system described herein in a variety of applications. For example, in a first use case, a user (also referred to herein as a “service user”) may be interested in identifying a number of end users who may be shopping for a home in a given geographical area within a certain time period (e.g., the last 24 hours) because such end users may be interested in mortgage services offered by the service user. With a single click (e.g., a single selection of a user interface element that, when selected, causes a user interface to open, such as a single user interface element within a splash screen), the service user may be able to visualize the desired data. Data regarding the individuals may be anonymized (e.g., the user interface may not display information that could be used to identify any particular end user) to protect consumer privacy. Once the desired set of end users is identified via the user interface (e.g., as shown in FIG. 5 via the selection of various filters), the user identification system described herein may allow the service user to create an ad campaign in which digital and/or physical advertisements are delivered to the end user's mobile device and/or mailing address, and to view a summary of the ad campaign. The user identification system described herein may also support direct customer relationship management (CRM) integrations, so the user identification system described herein can enrich a service user's CRM with information regarding the identified end users (e.g., update a data store that stores contact information for various end users with additional information regarding the identified end users) so that the service user can provide a tailored personal experience to the identified end users.

As another example, in a second use case, an end user may be in need of a loan (e.g., a home equity loan). The user identification system described herein can use location data and/or mobility patterns (e.g., mobility data, such as data identifying the movements of one or more end users over a period of time, which may be derived from data originating from the end users' mobile device) of end users, parcel data (e.g., data regarding various parcels, including geographic location, mailing address, number of bedrooms, number of bathrooms, square footage, unique identifier, etc.), and geospatial capabilities to predict a likelihood that an end user may benefit from a loan. For example, the user identification system described herein may train and use an artificial intelligence model (e.g., a machine learning model, a neural network, a language model, a transformation model, etc.) to generate the prediction, where inputs to the trained artificial intelligence model may include the location data and/or mobility patterns of a particular end user, parcel data corresponding to one or more parcels, and/or geospatial capabilities associated with the particular end user. As an illustrative example, the user identification system described herein may predict that an end user is more likely to be in need of a loan if, for example, the location data and/or mobility patterns indicate that the end user has recently visited a home improvement store, a wedding venue, or a college. A user interface generated by the user identification system may be capable of displaying the prediction for one or more end users in one or more geographical areas within a single view. For example, the user interface may provide a summary (e.g., a total number) of the end users who are predicted to be in need of a loan over a threshold likelihood and/or specific biographical, financial, and/or other related information about individual end users.

The foregoing aspects and many of the attendant advantages of this disclosure will become more readily appreciated as the same become better understood by reference to the following detailed description, when taken in conjunction with the accompanying drawings.

### Example End User Identification Environment

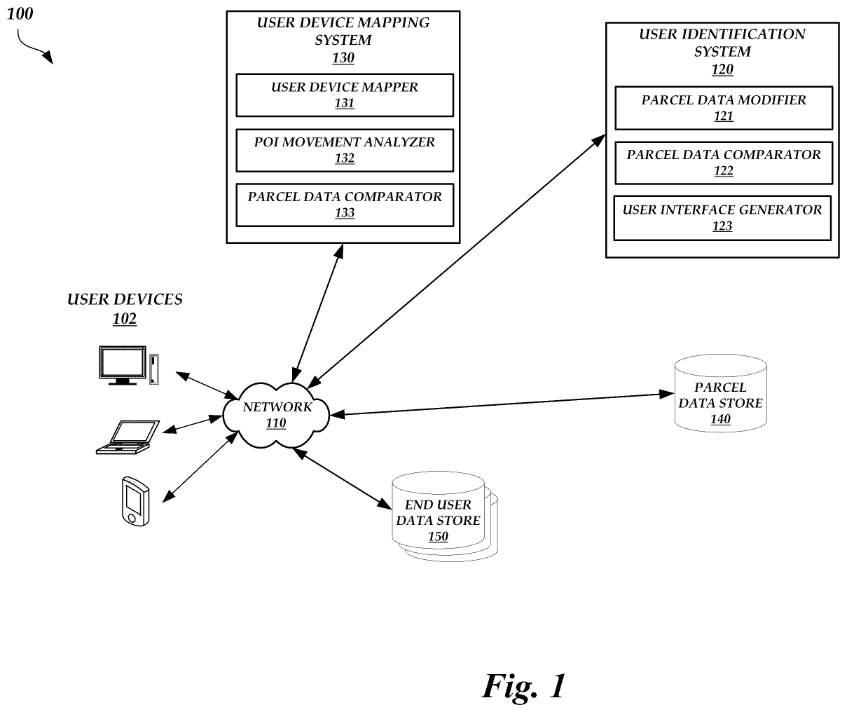

FIG. 1 is a block diagram of an illustrative operating environment 100 in which a user identification system 120 and a user device mapping system 130 use mobility data and/or parcel data to filter end users and identify those end users who may be interested in a specific type of product or service. The operating environment 100 further includes a parcel data store 140 and one or more end user data stores 150 that may communicate with the user identification system 120 and/or the user device mapping system 130 via a network 110 to provide parcel data and end user data, respectively. Furthermore, the operating environment 100 includes various user devices 102 operated by various service users that may communicate with the user identification system 120 to request and receive information about end users who may be interested in specific types of product or service offered by the service users.

The parcel data store 140 can store parcel data for one or more parcels or properties located in a geographic region (e.g., a neighborhood, a town, a city, a county, a state, a country, etc.). For example, the parcel data can include, for a particular parcel, a geographic location of the parcel, a mailing address of the parcel, a number of bedrooms in a structure on the parcel, a number of bathrooms in a structure on the parcel, square footage of a structure on the parcel, acreage of the parcel, a unique identifier of a structure on the parcel, a unique identifier of the parcel, whether the respective parcel is currently listed for sale or rent, whether the respective parcel was listed for sale or rent within a threshold time period (e.g., within the last 30 days, within the last 3 months, etc.), and/or the like. While the parcel data store 140 is depicted as being external to the user identification system 120 and the user device mapping system 130, this is not meant to be limiting. For example, the parcel data store 140 can be internal to the user identification system 120.

The end user data stores 150 may each store biographical information (e.g., a name, a birthdate, a social security number, email address, telephone number, name of spouse, name of children, place of employment, etc.), financial information (e.g., an outstanding loan amount, terms of an outstanding loan, monthly loan payments, information about a lender from whom a loan was obtained, estimated value of owned or rented property, estimated equity in real property, purchase recording date of real property, property type of owned or rented property, annual income, etc.), observational information (e.g., an indication that an end user is interested in renting or purchasing a home, an indication that an end user is looking for a home in a certain geographic region, an indication that an end user is looking for a specific type of product or service offered by a service user, an amount of time an end user spent at a parcel that is available on the market, a number of times an end user visited a parcel that is available on the market, whether the an end user has previously visited a parcel, details about the parcel for sale or rent that an end user visited (e.g., listing price, zip code, geographic location, days on market, listing identifier, etc.), an indication of whether an end user is seeking an in-state or out-of-state home (as compared to the end user's current residence), a date at which an end user began visiting parcels available on the market, a most recent date at which an end user visited a parcel available on the market (and/or an identification of the parcel), an average listing price of parcels visited by an end user, etc.), and/or any other type of contact information for one or more end users. In some embodiments, the observation information may not be present in an end user data store 150 until the user identification system 120 and/or user device mapping system 130 perform some or all of the operations described herein.

Each end user data store 150 may be managed or operated by a particular service user. Thus, observational information stored in an end user data store 150 may be specific to the service user and/or the products or services offered by the service user. An end user data store 150 may represent a storage location that can be accessed via a file transfer protocol (FTP), such as a folder stored on one or more computing systems that hosts a network-accessible FTP site (e.g., an FTP network site, an FTP website, etc.). Alternatively or in addition, the end user data store 150 may represent a storage location that stores a customer relationship management (CRM) file for the associated service user. Thus, any updates to the end user data store 150 may result in an update to the CRM file.

While the end user data store 150 is depicted as being external to other components in the operating environment 100, this is not meant to be limiting. For example, the end user data store 150 can be internal to a computing system (e.g., a server) managed by a service user, can be internal to a user device 102, and/or the like.

The user identification system 120 can be a computing system configured to identify parcels—and therefore end users—associated with a service user and that, based on mobility data and/or parcel data, are associated with end users who exhibit behavior that indicates that the end users may be interested in products or services offered by the service user. In addition, the user identification system 120 may be configured to generate user interface data that, when processed by a user device 102, causes the user device 102 to render and display a user interface that graphically depicts information about the identified parcels and/or end users.

The user identification system 120 may be a single computing device, or it may include multiple distinct computing devices, such as computer servers, logically or physically grouped together to collectively operate as a server system. The components of the user identification system 120 can each be implemented in application-specific hardware (e.g., a server computing device with one or more ASICs) such that no software is necessary, or as a combination of hardware and software. In addition, the modules and components of the user identification system 120 can be combined on one server computing device or separated individually or into groups on several server computing devices. In some embodiments, the user identification system 120 may include additional or fewer components than illustrated in FIG. 1.

In some embodiments, the features and services provided by the user identification system 120 may be implemented as web services consumable via the communication network 110. In further embodiments, the user identification system 120 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

The user device mapping system 130 can be a computing system configured to process mobility data and/or parcel data to identify which end users are associated with which parcels (e.g., identify residences of end users) and identify parcels visited by end users to which the end users are not otherwise associated (e.g., identify parcels other than end users' residences visited by end users). In addition, the user device mapping system 130 may be configured to identify end users associated with a service user and who, based on mobility data and/or parcel data, exhibit behavior that indicates that the end users may be interested in products or services offered by the service user.

The user device mapping system 130 may be a single computing device, or it may include multiple distinct computing devices, such as computer servers, logically or physically grouped together to collectively operate as a server system. The components of the user device mapping system 130 can each be implemented in application-specific hardware (e.g., a server computing device with one or more ASICs) such that no software is necessary, or as a combination of hardware and software. In addition, the modules and components of the user device mapping system 130 can be combined on one server computing device or separated individually or into groups on several server computing devices. In some embodiments, the user device mapping system 130 may include additional or fewer components than illustrated in FIG. 1.

The user device mapping system 130 may include various modules, components, data stores, and/or the like to provide the end user identification functionality described herein. For example, the user device mapping system 130 may include a user device mapper 131, a place of interest (POI) movement analyzer 132, and a parcel data comparator 133.

The user device mapper 131 may be configured to map end user devices to parcels. For example, end user devices may be user devices operated by end users. The user device mapper 131 can obtain mobility data from cellular service providers, GPS providers, network service providers (e.g., Internet service providers), and/or end user devices themselves to determine geographic locations to which various end user devices traveled. The mobility data can include data that identifies historical geographic locations of end user devices over time and/or data that identifies real-time geographic locations of end user devices (e.g., where a real-time geographic location may be a current geographic location of an end user device, such as a geographic location at which the end user device was positioned within a threshold period of time (e.g., 1 ms, 5 ms, 10 ms, 1 second, etc.) of the data being received by the POI movement analyzer 132). Mobility data can also be referred to herein as “mobile location data.” The mobility data may include an identification of various end user devices (e.g., an end user device identifier, such as a mobile device identifier or ID, an international mobile equipment identity (IMEI), a serial number, a radio identifier, a medium access control (MAC) address, an Internet protocol (IP) address, etc.) and an identification of various geographic locations visited by the respective end user devices. For individual end user devices, the user device mapper 131 can determine a geographic location at which the respective end user device spends the most time in a given time period (e.g., a day, a week, a month, a year, etc.) to be a residence of the end user that operates the respective end user device. The user device mapper 131 can then map the respective end user device to a particular parcel by obtaining parcel data, identifying a parcel that is associated with a geographic location (e.g., a physical address, geographic coordinates, etc.) that matches the determined geographic location, and mapping or linking an identification of the respective end user device (e.g., an end user device identifier, such as any of the identifiers or addresses identified herein) to the identified parcel or a physical address of the identified parcel. The user device mapper 131 can repeat this operation for one more end user devices.

The POI movement analyzer 132 may be configured to identify parcels (or physical addresses of parcels) that an end user device has visited that are not mapped to the end user device. For example, the POI movement analyzer 132 can obtain mobility data from cellular service providers, GPS providers, network service providers (e.g., Internet service providers), and/or end user devices themselves to determine geographic locations to which various end user devices traveled. For individual end user devices, the POI movement analyzer 132 can determine one or more geographic locations at which the respective end user device has spent at least a threshold amount of time (e.g., 15 minutes, 1 hour, 2 hours, etc.) in a given time period (e.g., a day, a week, a month, a year, etc.), has visited on at least two separate occasions in a given time period, and/or is not a geographic location associated with a parcel mapped to the respective end user device (e.g., is not a residence of the end user that operates the respective end user device). The POI movement analyzer 132 can then identify parcel(s) that are associated with geographic location(s) (e.g., a physical address, geographic coordinates, etc.) that match the determined geographic location(s), and generate a list of the identified parcel(s). The POI movement analyzer 132 can repeat this operation for one more end user devices.

The parcel data comparator 133 may be configured to obtain a list of parcels managed by or otherwise of interest to a service user (e.g., parcels for which the owners are current or potential customers of the service user), identify an end user device that is mapped to each parcel in the list (e.g., identify an end user device that is mapped or linked to each parcel or a physical address of each parcel in the list), and filter the lists of identified parcel(s) (or physical addresses) generated by the POI movement analyzer 132 such that the lists of identified parcel(s) (or physical addresses) that remain are each associated with one of the identified end user devices. In other words, the parcel data comparator 133 may narrow the data to be processed to just the data on parcels that were visited by end user devices mapped to (e.g., are operated by end users that have a residence at) a parcel that is managed or otherwise of interest to a service user.

For individual end user devices mapped to at least one parcel in the list of parcels managed by or otherwise of interest to a service user, the parcel data comparator 133 may be configured to filter the list of identified parcel(s) associated with the respective end user device and generated by the POI movement analyzer 132 to identify those parcel(s) that are available on the market to buy, rent, or otherwise access. For example, the parcel data comparator 133 can receive a list of parcels that are available on the market directly or indirectly from the parcel data store 140. Optionally, each of the parcels in the list of parcels that are available on the market may be represented by a unique identifier (e.g., an identifier that is unique to each parcel). The POI movement analyzer 132 may also represent the parcels included in the list of identified parcel(s) generated by the POI movement analyzer 132 with unique identifiers. For individual end user devices mapped to at least one parcel in the list of parcels managed by or otherwise of interest to a service user, the parcel data comparator 133 can then compare the list of parcels that are available on the market with the list of identified parcel(s) generated by the POI movement analyzer 132 (e.g., compare physical addresses included in the lists, compare unique identifiers included in the lists, etc.) to identify those parcel(s) that are on both lists. If at least one parcel is identified on both lists, this may indicate that the end user that operates the respective end user device is exhibiting behavior that shows that the end user is likely interested in a product or service offered by the service user. As an illustrative example, if at least one parcel is identified on both lists, this may indicate that the end user that operates the respective end user device is exhibiting behavior that shows that the end user is looking for a home and is likely interested in mortgage or loan products or services offered by the service user.

In response to a determination that at least one parcel is identified on both lists for a respective end user device, the parcel data comparator 133 can perform an action. For example, the parcel data comparator 133 can update the end user data store 150 to include additional information about the end user of the respective end user device, such as information that indicates that the end user is interested in renting or purchasing a home, is looking for a home in a certain geographic region (e.g., a geographic region in which some or all of the parcels identified on both lists are located), and/or is looking for any other product or service offered by the service user. In addition, the parcel data comparator 133 can update the end user data store 150 to include specific observations about the end user and/or respective end user device. For example, the observations can include an amount of time the respective end user device spent at each parcel identified on both lists, a number of times the respective end user device visited each parcel identified on both lists, whether the respective end user device has previously visited a parcel identified on both lists, details about the parcel for sale or rent that the respective end user device visited (e.g., listing price, zip code, geographic location, days on market, listing identifier, etc.), whether the respective end user device visited a parcel identified on both lists that is in a different state than a state at which the corresponding end user resides, a date at which the end user of the respective end user device began visiting parcels identified on both lists, a most recent date at which the end user of the respective end user device visited a parcel available on the market (and/or an identification of the parcel), an average listing price of parcels visited by the end user of the respective end user device, and/or the like. As described above, updating the end user data store 150 may result in an update to a CRM file stored therein, where the CRM file may be updated to include any of the information described herein.

Additional details of the user mapping system 130 can be found, for example, in U.S. Pat. Nos. 11,115,380, 10,834,048, 10,263,949, 9,742,727, 9,515,984, 11,010,789, 10,348,842, 11,694,222, 10,932,118, 11,438,754, which are hereby incorporated by reference herein in their entireties.

The user identification system 120 may include various modules, components, data stores, and/or the like to provide the end user identification and user interface generation functionality described herein. For example, the user identification system 120 may include a parcel data modifier 121, a parcel data comparator 122, and a user interface generator 123.

The parcel data modifier 121 may be configured to modify a list of parcels provided by a service user to include unique identifiers for each parcel. For example, a service user via a user device 102 may provide access to the end user data store 150 associated with the service user that includes a list of parcels or may provide a file that includes a list of parcels (e.g., via an upload function available on a network page, as described in greater detail below). The list of parcels may identify each parcel by a physical mailing address, a set of geographic coordinates, and/or the like. The parcel data modifier 121 can access the parcel data store 140 to retrieve unique identifiers for each parcel included in the list provided by the service user. Once retrieved, the parcel data modifier 121 can generate a data file that includes a list of retrieved unique identifiers and/or can modify the list of parcels provided by the service user to replace a previous identification of the parcels (e.g., physical mailing address, set of geographic coordinates, etc.) with the corresponding unique identifiers.

The parcel data comparator 122 may be configured to perform at least some of the same operations as the parcel data comparator 133. For example, the parcel data comparator 122 may be configured to obtain a list of parcels managed by or otherwise of interest to a service user, identify an end user device that is mapped to each parcel in the list, and filter the lists of identified parcel(s) generated by the POI movement analyzer 132 such that the lists of identified parcel(s) that remain are each associated with one of the identified end user devices. In other words, the parcel data comparator 122 may narrow the data to be processed to just the data on parcels that were visited by end user devices mapped to (e.g., are operated by end users that have a residence at) a parcel that is managed or otherwise of interest to a service user.

For individual end user devices mapped to at least one parcel in the list of parcels managed by or otherwise of interest to a service user, the parcel data comparator 122 may be configured to filter the list of identified parcel(s) associated with the respective end user device and generated by the POI movement analyzer 132 to identify those parcel(s) that are available on the market to buy, rent, or otherwise access. For example, the parcel data comparator 122 can receive a list of parcels that are available on the market directly or indirectly from the parcel data store 140. Optionally, each of the parcels in the list of parcels that are available on the market may be represented by a unique identifier (e.g., an identifier that is unique to each parcel). The POI movement analyzer 132 may also represent the parcels included in the list of identified parcel(s) generated by the POI movement analyzer 132 with unique identifiers. For individual end user devices mapped to at least one parcel in the list of parcels managed by or otherwise of interest to a service user, the parcel data comparator 122 can then compare the list of parcels that are available on the market with the list of identified parcel(s) generated by the POI movement analyzer 132 (e.g., compare physical addresses included in the lists, compare unique identifiers included in the lists, etc.) to identify those parcel(s) that are on both lists. If at least one parcel is identified on both lists, this may indicate that the end user that operates the respective end user device is exhibiting behavior that shows that the end user is likely interested in a product or service offered by the service user. As an illustrative example, if at least one parcel is identified on both lists, this may indicate that the end user that operates the respective end user device is exhibiting behavior that shows that the end user is looking for a home and is likely interested in mortgage or loan products or services offered by the service user.

In response to a determination that at least one parcel is identified on both lists for a respective end user device, the parcel data comparator 122 can perform an action. For example, the parcel data comparator 122 can update the end user data store 150 to include additional information about the end user of the respective end user device, such as information that indicates that the end user is interested in renting or purchasing a home, is looking for a home in a certain geographic region (e.g., a geographic region in which some or all of the parcels identified on both lists are located), and/or is looking for any other product or service offered by the service user. In addition, the parcel data comparator 122 can update the end user data store 150 to include specific observations about the end user and/or respective end user device. For example, the observations can include an amount of time the respective end user device spent at each parcel identified on both lists, a number of times the respective end user device visited each parcel identified on both lists, whether the respective end user device has previously visited a parcel identified on both lists, details about the parcel for sale or rent that the respective end user device visited (e.g., listing price, zip code, geographic location, days on market, listing identifier, etc.), whether the respective end user device visited a parcel identified on both lists that is in a different state than a state at which the corresponding end user resides, and/or the like. As described above, updating the end user data store 150 may result in an update to a CRM file stored therein, where the CRM file may be updated to include any of the information described herein.

As another example, the parcel data comparator 122 can cause the user interface generator 123 to generate new or updated user interface data that, when processed by a user device 102, causes the user device 102 to render and display a user interface that graphically depicts some or all of the additional information and/or specific observations described above and/or any end user data stored in the end user data store 150. Specifically, the user interface generator 123 may be configured to generate user interface data that, when processed by a user device 102, causes the user device 102 to render and display a user interface. The user interface may allow a service user to log in (via a user device 102) and access an account associated with the service user. Once logged in, the user interface may allow a service user to upload a list of parcels, such as a list of parcels managed by the service user and/or parcels owned or rented by end users that are customers of the service user. As described above, the list of parcels may include an identification of one or more parcels, such as a physical mailing address of the parcels. Optionally, each entry in the list of parcels may include end user contact information, such as a name of the end user associated with the respective parcel, an email address of the end user associated with the respective parcel, a phone number of the end user associated with the respective parcel, and/or the like. The parcel data modifier 121 may receive the list of parcels uploaded via the user interface and can optionally perform a validation operation to, for example, confirm that physical mailing addresses included in the list are valid addresses and/or to confirm that the file is in an expected format.

If the optional validation operation succeeds, the parcel data modifier 121, parcel data comparator 122, and/or the parcel data comparator 133 can perform some or all of the operations described herein. The parcel data comparator 122 can provide the results of the operations (e.g., generation of the additional information and/or the specific observations) to the user interface generator 123. The user interface generator 123 can then generate updated user interface data that, when processed by the user device 102, causes the user device 102 to render and display an updated user interface (such as the user interface illustrated in FIG. 5). The updated user interface may depict a list of end users associated with the service user, a list of end users associated with the service user that are exhibiting behavior that may indicate that such end users may be in need of a service or product offered by the service user, and/or a geographic map. The list of end users can include details about each end user, such as biographical information, financial information, observational information, and/or any other type of contact information. Optionally, some or all of the biographical information, financial information, observational information, and/or other contact information may initially be hidden from view in the updated user interface. In response to a service user selecting a particular end user (e.g., by clicking on, hovering over, tapping on, etc. a portion of the updated user interface that identifies the end user), a new window (e.g., a pop-up window, a new window in the updated user interface that is adjacent to the list of end users and/or the geographic map, etc.) may appear that depicts some or all of hidden biographical information, financial information, observational information, and/or other contact information. The geographic map may depict the geographic location of one or more end users associated with the service user, such as one or more end users that are exhibiting behavior that may indicate that such end users may be in need of a service or product offered by the service user.

The updated user interface may further include one or more filters that, when enabled, may cause the list of end users and/or the geographic map to change. For example, the updated user interface may allow a service user to filter information depicted in the user interface by geography (e.g., by county, state, zip code, in-state (e.g., end users looking to buy or rent homes in the same state that they reside), out-of-state (e.g., end users looking to buy or rent homes in a different state than they reside), etc.), by new end users (e.g., end users who have been newly identified, within a threshold time period, of exhibiting behavior indicating that they may be in need of a service or product offered by the service user), by low-to-moderate income (LMI) shoppers (e.g., end users who have an annual income less than a threshold amount, such as $100,000, $50,000, $30,000, etc.), by end user behavior (e.g., home shopping activity, auto shopping activity, etc.), by contact status (e.g., to be contacted (e.g., the service user has not yet offered a service or product to the end user as a result of execution of the operations described herein), follow up (e.g., the service user has offered a service or product to the end user as a result of execution of the operations described herein, but has not received an answer from the end user yet), moving to pre-qualification (e.g., the service user has pre-qualified the end user), could not reach (e.g., the service user could not reach the end user in an attempt to offer a service or product), not in the market (e.g., the service user has confirmed that the end user is not interested in a service or product offered by the service user), opt out (e.g., the end user has indicated that the end user wishes to opt out of receiving information about new products or services offered by the service user), etc.), by assignment (e.g., a service user in a team of service users assigned to the end user), and/or the like. In response to selection of a filter by geography, the updated user interface may update the geographic map to depict only the geographic region identified in the filter (and exclude depiction of other geographic regions and/or end users associated with the other geographic regions).

The updated user interface may further allow a service user to export data. For example, the updated user interface may allow a service user to export a list of end users who have exhibited behavior indicating that such end users may be interested in a service or product offered by the service user. The data exported can include biographical information, financial information, observational information, and/or any other type of contact information. The data exported can be formatted into a file format that can be accessed by the user device 102 and/or stored in the end user data store 150. As one illustrative example, the file generated in response to a service user exporting data via the updated user interface can be a CRM file that can replace one stored in the end user data store 150, can be a CRM file or spreadsheet file that can be joined with an existing CRM file in the end user data store 150, and/or can be a new spreadsheet file separate from a new or existing CRM file that can be stored by the user device 102 or in the end user data store 150.

Optionally, the user identification system 120 and/or the user device mapping system 130 can use supplemental data to determine whether an end user device is exhibiting behavior that shows that the end user is likely interested in a product or service offered by the service user. For example, the supplemental data can include messages (e.g., text messages, emails, etc.) received from the end user that relate to the product or service, an application for the product or service submitted by the end user, an inquiry received from the end user about a related product or service to the subject product or service, an inquiry received from the end user about concluding the product or service on a currently owned parcel, an indication that the end user viewed a message or advertisement related to the product or service, and/or any other type of data that demonstrates that an end user performed an action or is the subject of an action that is associated with a behavior that shows that the end user is likely interested in a product or service offered by the service user. If the user identification system 120 and/or the user device mapping system 130 identifies at least one parcel on both lists and identifies one or more supplemental data items corresponding to the end user, this may indicate that the end user that operates the respective end user device is exhibiting behavior that shows that the end user is likely interested in a product or service offered by the service user, and the user identification system 120 and/or the user device mapping system 130 can perform a corresponding action as described herein.

Optionally, the user identification system 120 and/or the user device mapping system 130 can serve digital advertisements to end user devices. For example, the user device mapper 131 may determine an Internet protocol (IP) address of various end user devices. When a request for a content page (e.g., a network page, a web page, etc.) or other digital content originates from an IP address mapped to an end user device operated by an end user identified as exhibiting behavior indicating that the end user may be interested in a service or product offered by a service user, the user identification system 120 and/or the user device mapping system 130 can generate or obtain a digital advertisement (e.g., a content page banner advertisement, a social media advertisement, a native advertisement, a video file, an image file, an audio file (e.g., programmatic audio), etc.) that provides details on the service or product offered by the service user and cause the end user device to display the digital advertisement. Specifically, the user identification system 120 and/or the user device mapping system 130 can insert or cause another computing system to insert the digital advertisement in a content page or other digital content returned to the end user device. Thus, the digital advertisement may be delivered to the end user device as part of an over-the-top (OTT) media service that serves content to end user devices. If an end user selects a digital advertisement (e.g., a click through occurs), the digital advertisement may be configured (e.g., by the user identification system 120 and/or the user device mapping system 130) to direct the end user device to open a network page served by the service user that provides information on the service or product offered by the service user in which the end user may be interested. Alternatively or in addition, the user identification system 120 and/or the user device mapping system 130 can create and print or cause another system to create and print a physical mailer that provides details on the service or product offered by the service user. The physical mailer can then be mailed to a physical address associated with the end user device.

In further embodiments, the user identification system 120 can monitor the behavior of end users that have received digital advertisements and/or physical mailers (e.g., determine whether a click through occurred, whether the physical mailer led to a call or email to the service user, etc.) and cause targeted messages to be sent to the end user devices and/or the end users (e.g., additional digital advertisements, physical mailers, etc.). The user identification system 120 can generate reports based on the monitoring (e.g., identify end users who have responded to advertisements, identify end users who have not responded to advertisements, identify end users who have indicated that are interested in a service or product, identify end users who have indicated they are not interested in a service or product, identify end users who have responded to the advertisements by purchasing or contracting for a service or product offered by a service user, identify an amount earned by the service user in response to end users purchasing or contracting for a service or product offered by the service user, identify an amount of money spent on advertisements, identify a number of advertisements sent to end users, identify types of advertisements sent to end users, etc.) on a periodic basis (e.g., weekly, monthly, bi-monthly, quarterly, annually, etc.) and provide those reports to the service user via the user device 102.

In further embodiments, the user identification system 120 can use location data and/or mobility patterns (e.g., mobility data, such as data identifying the movements of one or more end users over a period of time, which may be derived from data originating from the end users' mobile device, where the mobility data may identify the number of visits to a particular location, the type of location visited (e.g., type of vehicle dealership, brand of automotive dealership, type of retailer, brand of retailer, type of property (e.g., commercial, industrial, residential, two story home, three story home, single family home, apartment, duplex, etc.), etc.) of end users, parcel data (e.g., data regarding various parcels, including geographic location, mailing address, number of bedrooms, number of bathrooms, square footage, unique identifier, etc.), and/or geospatial capabilities to predict a likelihood that an end user may benefit from a service or product offered by a service user (e.g., a loan, a mortgage, a home equity line of credit, etc.). For example, the user identification system 120 may train an artificial intelligence model (e.g., a machine learning model, a neural network, a language model, a transformation model, etc.) to generate the prediction using training data. The training data can include, in each training data item, location data, mobility patterns, parcel data, and/or geospatial capabilities associated with an end user, where each training data item may be labeled with an indication of whether the end user purchased, contracted for, applied for, or otherwise obtained a service or product offered by a service user. The user identification system 120 can provide inputs to the trained artificial intelligence model that may include the location data and/or mobility patterns of a particular end user, parcel data corresponding to one or more parcels, and/or geospatial capabilities associated with the particular end user, which may result in the artificial intelligence model outputting a prediction of whether the end user may be interested in a particular type of service or product offered by a service user. The prediction may be in the form of a propensity score, where a higher propensity score may indicate a higher likelihood that the end user is interested in a particular type of service or product offered by a service user. As an illustrative example, the user identification system 120 may predict that an end user is more likely to be in need of a loan if, for example, the location data and/or mobility patterns indicate that the end user has recently visited a home improvement store, a wedding venue, or a college. As another illustrative example, the user identification system 120 may predict that an end user is more likely to purchase a specific type of vehicle based on the brand of automotive dealerships visited by the end user. As another illustrative example, the user identification system 120 may predict that an end user is more likely to purchase a product or service offered by a service user based on the number or velocity of visits by the end user to a particular location associated with the product or service. A user interface caused to be generated by the user interface generator 123 may be capable of displaying the prediction (e.g., likelihood or propensity score) for one or more end users in one or more geographical areas within a single view. For example, the user interface may provide a summary (e.g., a total number) of the end users who are predicted to be in need of a loan over a threshold likelihood or propensity score and/or specific biographical, financial, and/or other related information about individual end users.

The user identification system 120 and/or user device mapping system 130 may further execute operations to protect personally identifiable information (e.g., names, addresses, phone numbers, email addresses, dates of birth, social security numbers, etc.). For example, the user identification system 120 and/or user device mapping system 130 may apply a hash algorithm (e.g., SHA-256, SHA-512, etc.) to any personally identifiable information received from the parcel data store 140, received from the end user data store 150, included in the mobility data, and/or the like to mask the personally identifiable information. The user identification system 120 and/or user device mapping system 130 can then perform some or all of the operations described herein using the masked personally identifiable information.

While the present disclosure is described herein with respect to identifying end users that may be interested in purchasing a home, this is for illustrative purposes only and is not meant to be limiting. For example, the techniques and functionality described herein can be used to identify end users that may be interested in purchasing a vehicle, remodeling or improving a home or structure, applying for a loan for recreational purposes, applying for a loan for educational purposes, and/or the like. When the techniques and functionality described herein are used to identify end users that may be exhibiting behavior other than the purchase of a home, any user interfaces that are generated may include one or more filters that are specific to the type of behavior being exhibited (e.g., a filter for vehicle brand or vehicle type when an end user appears to be trying to purchase a vehicle; a filter for material type, types of appliances, types of light fixtures, etc. when an end user appears to be trying to remodel a home; a filter for interest rates, loan terms, types of lenders, etc. when an end user appears to be trying to apply for a loan; etc.) so that the service user can filter end users in a manner that corresponds with the use case. Optionally, such filters may be obtained from a first or third party data store, not shown.

### Example Block Diagram for Identifying Geographic Locations Visited by End User Devices

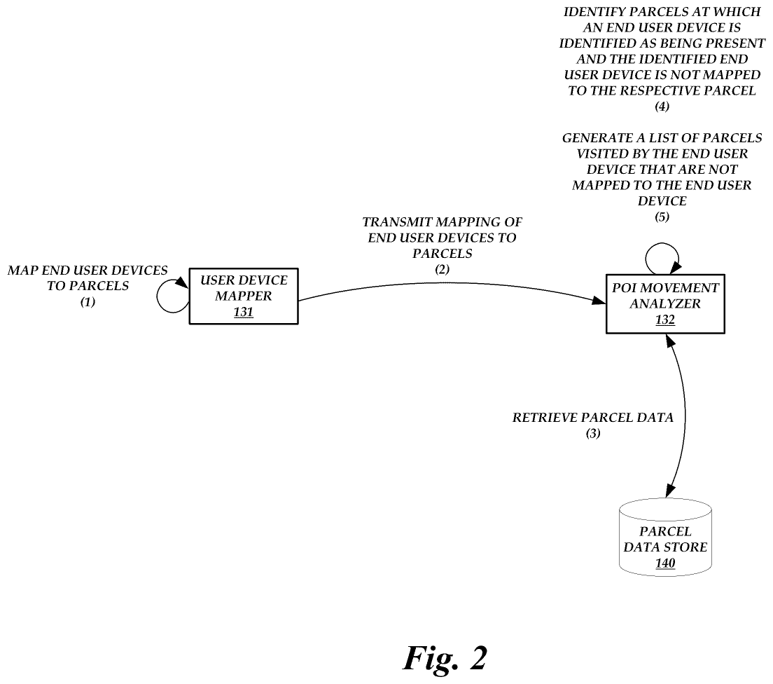

FIG. 2 is a flow diagram illustrating the operations performed by the components of the operating environment 100 of FIG. 1 to identify geographic locations visited by end user devices. As illustrated in FIG. 2, the user device mapper 131 may map end user devices to parcels at (1). For example, user device mapper 131 can obtain mobility data and use the mobility data to determine that a geographic location at which the respective end user device spends the most time in a given time period (e.g., a day, a week, a month, a year, etc.) to be a residence of the end user that operates the respective end user device. The user device mapper 131 can then map the respective end user device to a particular parcel by obtaining parcel data, identifying a parcel that is associated with a geographic location (e.g., a physical address, geographic coordinates, etc.) that matches the determined geographic location, and mapping or linking the respective end user device to the identified parcel. The user device mapper 131 can then transmit the mapping of the end user devices to parcels to the POI movement analyzer 132 at (2).

The POI analyzer 132 can retrieve parcel data from the parcel data store 140 at (3), where the parcel data can include an identification of the geographic location of various parcels. The POI analyzer 132 can then use the parcel data to identify parcels at which an end user device is identified as being present and the identified end user device is not mapped to the respective parcel at (4). For example, the POI analyzer 132 can use the information provided by the user device mapper 131 to determine which end user devices are mapped to which parcels. The POI analyzer 132 can then use mobility data to identify other geographic locations at which the end user device visited, and determine which geographic locations are ones that are not the same as the geographic location of the parcel mapped to the end user device. The POI analyzer 132 can then use the parcel data to identify parcels that correspond with these other geographic locations.

The POI analyzer 132 can then generate a list of parcels visited by the end user device that are not mapped to the end user device at (5). The POI analyzer 132 can repeat the operations (3), (4), and/or (5) for one or more end user devices.

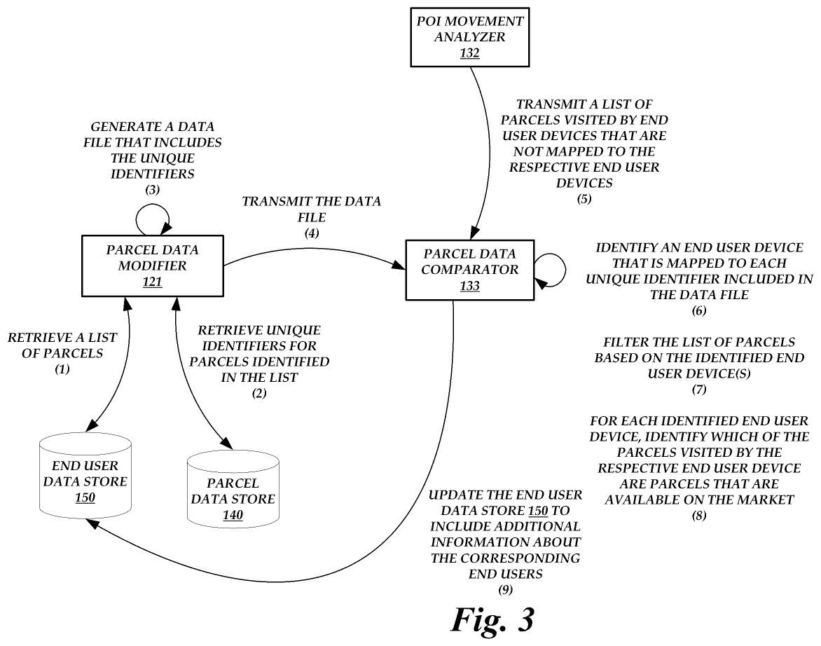

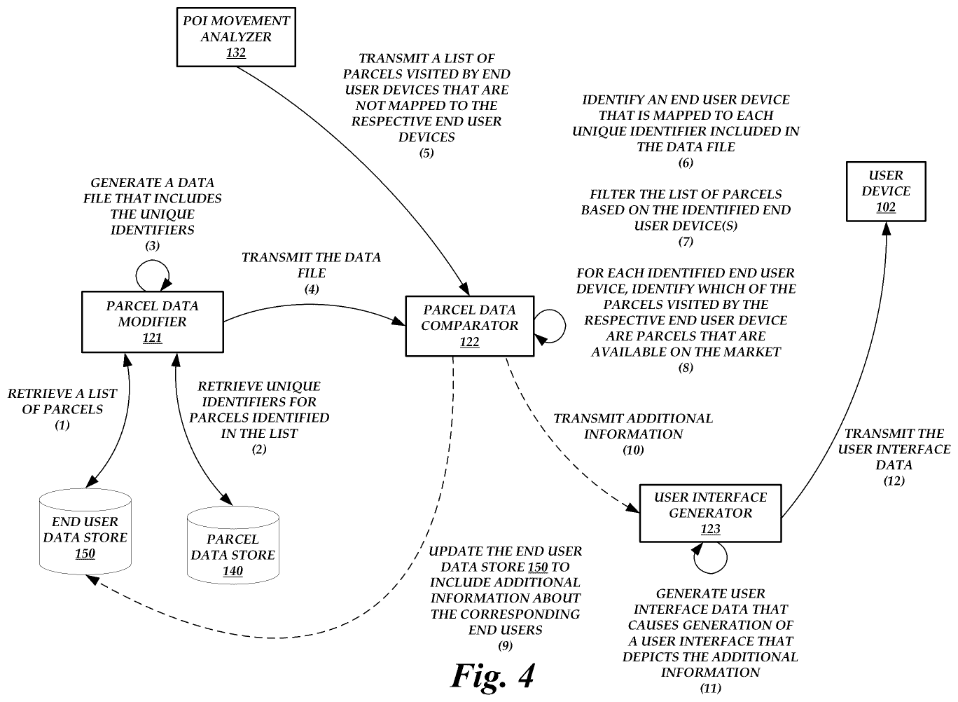

The operations described herein with respect to FIG. 2 may be performed periodically and/or asynchronously from the operations described below with respect to FIGS. 3-4.

### Example Block Diagrams for Identifying End Users Exhibiting Actionable Behavior

FIG. 3 is a flow diagram illustrating the operations performed by the components of the operating environment 100 of FIG. 1 to identify end users exhibiting actionable behavior (e.g., exhibiting behavior indicating that the end users may be interested in a service or product offered by a service user). The operations depicted in FIG. 3 may be executed in response to a service user via a user device 102 providing a data file that identifies a list of parcels managed or otherwise of interest to the service user. For example, the data file can be a CRM file. The operations depicted in FIG. 3 may also be executed automatically on a periodic basis without any explicit request from a service user.

As illustrated in FIG. 3, the parcel data modifier 121 can retrieve a list of parcels from the end user data store 150 at (1). For example, the parcel data modifier 121 can retrieve the list in response to a service user that manages the end user data store 150 requesting that the list be accessed. Alternatively or in addition, the parcel data modifier 121 can receive the list from a user device 102, such as a user device 102 that uploads the list to the parcel data modifier 121. Before, during, and/or after retrieving the list of parcels, the parcel data modifier 121 can retrieve unique identifiers for the parcels identified in the list from the parcel data store 140 at (2).

The parcel data modifier 121 can generate a data file that includes the unique identifiers at (3). For example, the parcel data modifier 121 can replace information identifying various parcels in the list provided by the service user with unique identifiers corresponding to those parcels. Thus, the information provided by the service user may be anonymized. The parcel data modifier 121 can then transmit the data file to the parcel data comparator 133 at (4). Optionally, the parcel data comparator 133 may apply another unique identifier to each unique identifier included in the data file and/or replace each unique identifier included in the data file with another unique identifier (e.g., referred to herein as a “second unique identifier”).

Before, during, and/or after the data file is transmitted to the parcel data comparator 133, the POI movement analyzer 132 may transmit to the parcel data comparator 133 a list of parcels visited by end user devices that are not mapped to the respective end user devices at (5). In other words, the POI movement analyzer 132 may transmit to the parcel data comparator 133 a list of parcels that were visited by end users that operate the end user devices.

The parcel data comparator 133 can then use the data file—which indicates parcels managed by or otherwise of interest to a service user—and/or the mapping produced by the user device mapper 131 to identify an end user device that is mapped to each unique identifier (e.g., each parcel) included in the data file at (6). The parcel data comparator 133 can then filter the list of parcels provided by the POI movement analyzer 132 based on the identified end user device(s) at (7) such that the portion of the list that remains is a list of parcels visited by one of the end user devices that is mapped to each unique identifier. In other words, the parcel data comparator 133 can filter the list to identify each parcel visited by an end user that is associated with a parcel managed by or otherwise of interest to the service user.

For each identified end user device, the parcel data comparator 133 can then use parcel data to identify which of the parcels visited by the respective end user device are parcels that are available for sale or rent on the market at (8), if any. If at least one parcel visited by the respective end user device is a parcel that is available for sale or rent, this may indicate that the corresponding end user is searching for a new home. In response, the parcel data comparator 133 can update the end user data store 150 to include additional information and/or observations about the respective end user at (9). Optionally, the parcel data comparator 133 can offer an application programming interface (API) that allows service users to submit API calls via user devices 102 that identify a list of parcels or physical addresses and that, when received by the parcel data comparator 133, causes the parcel data comparator 133 to transmit the additional information and/or observations corresponding to the list of parcels or physical addresses in response.

FIG. 4 is another flow diagram illustrating the operations performed by the components of the operating environment 100 of FIG. 1 to identify end users exhibiting actionable behavior (e.g., exhibiting behavior indicating that the end users may be interested in a service or product offered by a service user). The operations depicted in FIG. 4 may be executed in response to a service user uploading, via a user device 102, a data file that identifies a list of parcels managed or otherwise of interest to the service user. For example, the data file can be a CRM file. The operations depicted in FIG. 4 may also be executed automatically on a periodic basis without any explicit request from a service user.

As illustrated in FIG. 4, the parcel data modifier 121 can retrieve a list of parcels from the end user data store 150 at (1). For example, the parcel data modifier 121 can retrieve the list in response to a service user that manages the end user data store 150 requesting that the list be accessed. Alternatively or in addition, the parcel data modifier 121 can receive the list from a user device 102, such as a user device 102 that uploads the list to the parcel data modifier 121. Before, during, and/or after retrieving the list of parcels, the parcel data modifier 121 can retrieve unique identifiers for the parcels identified in the list from the parcel data store 140 at (2).

The parcel data modifier 121 can generate a data file that includes the unique identifiers at (3). For example, the parcel data modifier 121 can replace information identifying various parcels in the list provided by the service user with unique identifiers corresponding to those parcels. Thus, the information provided by the service user may be anonymized. The parcel data modifier 121 can then transmit the data file to the parcel data comparator 122 at (4).

Before, during, and/or after the data file is transmitted to the parcel data comparator 122, the POI movement analyzer 132 may transmit to the parcel data comparator 122 a list of parcels visited by end user devices that are not mapped to the respective end user devices at (5). In other words, the POI movement analyzer 132 may transmit to the parcel data comparator 122 a list of parcels that were visited by end users that operate the end user devices.

The parcel data comparator 122 can then use the data file—which indicates parcels managed by or otherwise of interest to a service user—and/or the mapping produced by the user device mapper 131 to identify an end user device that is mapped to each unique identifier (e.g., each parcel) included in the data file at (6). The parcel data comparator 122 can then filter the list of parcels provided by the POI movement analyzer 132 based on the identified end user device(s) at (7) such that the portion of the list that remains is a list of parcels visited by one of the end user devices that is mapped to each unique identifier. In other words, the parcel data comparator 122 can filter the list to identify each parcel visited by an end user that is associated with a parcel managed by or otherwise of interest to the service user.

For each identified end user device, the parcel data comparator 122 can then use parcel data to identify which of the parcels visited by the respective end user device are parcels that are available for sale or rent on the market at (8), if any. If at least one parcel visited by the respective end user device is a parcel that is available for sale or rent, this may indicate that the corresponding end user is searching for a new home.

In response, the parcel data comparator 122 can optionally update the end user data store 150 to include additional information and/or observations about the respective end user at (9) (e.g., join the additional information and/or observations to data already present in the CRM file, where the join may occur using the parcel unique identifiers as the join key). Optionally, the parcel data comparator 122 can offer an application programming interface (API) that allows service users to submit API calls via user devices 102 that identify a list of parcels or physical addresses and that, when received by the parcel data comparator 122, causes the parcel data comparator 122 to transmit the additional information and/or observations corresponding to the list of parcels or physical addresses in response.

Alternatively or in addition, the parcel data comparator 122 can transmit the additional information and/or observations to the user interface generator 123 at (10). The user interface generator 123 can generate user interface data that causes generation of a user interface that depicts the additional information and/or observations at (11). For example, the user interface may be user interface 500 depicted in FIG. 5. The user interface generator 123 can then transmit the user interface data to the user device 102 at (12), which causes the user device 102 to process the user interface data and render and display the user interface.

### Example User Interface

FIG. 5 illustrates an example user interface 500 that depicts information about end users associated with a service user and that exhibit behavior that indicates that the end users may be interested in a service or product offered by the service user. For example, the user interface 500 can be displayed by a user device 102 in response to processing user interface data generated by the user interface generator 123.

As illustrated in FIG. 5, a service user has logged into an account and uploaded a list of parcels, such as a list of parcels managed by the service user and/or parcels owned or rented by end users that are customers of the service user. In response, the parcel data modifier 121, parcel data comparator 122, and/or the parcel data comparator 133 can perform some or all of the operations described herein. The parcel data comparator 122 can provide the results of the operations (e.g., generation of the additional information and/or the specific observations) to the user interface generator 123. The user interface generator 123 can then generate updated user interface data that, when processed by the user device 102, causes the user device 102 to render and display the user interface 500.

The user interface 500 may depict a list of end users associated with the service user, a list 505 of end users associated with the service user that are exhibiting behavior that may indicate that such end users may be in need of a service or product offered by the service user, and/or a geographic map 510. The list 505 of end users can include details about each end user, such as biographical information, financial information, observational information, and/or any other type of contact information. As an illustrative example, the list 505 includes end user Avery Andrews. The list 505 identifies a name of the end user (e.g., Avery Andrews), a current address of the end user (e.g., 3800 Northridge Ct, Irving, TX 75038-4823), an indication of whether the end user is the owner of the parcel with the identified current address (e.g., yes), a contact status (e.g., to be contacted), a service user team member assignment (e.g., not assigned), a number of houses visited by the end user (e.g., 14), a number of houses visited multiple times by the end user (e.g., 0), an average listing price of houses visited by the end user (e.g., $250K-$500K), a date of last activity by the end user (e.g., July 20), and an indication of whether the end user is looking for an in-state or out-of-state property (e.g., in-state).

Optionally, some or all of the biographical information, financial information, observational information, and/or other contact information may initially be hidden from view in the user interface 500. In response to a service user selecting a particular end user (e.g., by clicking on, hovering over, tapping on, etc. a portion of the user interface 500 that identifies the end user), a new window (e.g., a pop-up window, a new window in the user interface 500 that is adjacent to the list 505 of end users and/or the geographic map 510, etc.) may appear that depicts some or all of hidden biographical information, financial information, observational information, and/or other contact information. The geographic map 510 may depict the geographic location of one or more end users associated with the service user, such as one or more end users that are exhibiting behavior that may indicate that such end users may be in need of a service or product offered by the service user.

The user interface 500 may further include one or more filters 515A-G that, when enabled, may cause the list 505 of end users and/or the geographic map 510 to change. For example, the user interface 500 may allow a service user to filter information depicted in the user interface by geography using filters 515A-C (e.g., by county, state, zip code, in-state (e.g., end users looking to buy or rent homes in the same state that they reside), out-of-state (e.g., end users looking to buy or rent homes in a different state than they reside), etc.), by new end users using filter 515D (e.g., end users who have been newly identified, within a threshold time period, of exhibiting behavior indicating that they may be in need of a service or product offered by the service user), by low-to-moderate income (LMI) shoppers using filter 515E (e.g., end users who have an annual income less than a threshold amount, such as $100,000, $50,000, $30,000, etc.), by end user behavior (e.g., home shopping activity, auto shopping activity, etc.), by contact status using filter 515F (e.g., to be contacted (e.g., the service user has not yet offered a service or product to the end user as a result of execution of the operations described herein), follow up (e.g., the service user has offered a service or product to the end user as a result of execution of the operations described herein, but has not received an answer from the end user yet), moving to pre-qualification (e.g., the service user has pre-qualified the end user), could not reach (e.g., the service user could not reach the end user in an attempt to offer a service or product), not in the market (e.g., the service user has confirmed that the end user is not interested in a service or product offered by the service user), opt out (e.g., the end user has indicated that the end user wishes to opt out of receiving information about new products or services offered by the service user), etc.), by assignment using filter 515G (e.g., a service user in a team of service users assigned to the end user), and/or the like. In response to selection of a filter by geography, the user interface 500 may update the geographic map 510 to depict only the geographic region identified in the filter (and exclude depiction of other geographic regions and/or end users associated with the other geographic regions).

The user interface 500 may further allow a service user to export data (not shown). For example, the user interface 500 may allow a service user to export a list of end users who have exhibited behavior indicating that such end users may be interested in a service or product offered by the service user. The data exported can include biographical information, financial information, observational information, and/or any other type of contact information. The data exported can be formatted into a file format that can be accessed by the user device 102 and/or stored in the end user data store 150. As one illustrative example, the file generated in response to a service user exporting data via the updated user interface can be a CRM file that can replace one stored in the end user data store 150, can be a CRM file or spreadsheet file that can be joined with an existing CRM file in the end user data store 150, and/or can be a new spreadsheet file separate from a new or existing CRM file that can be stored by the user device 102 or in the end user data store 150.

### Example End User Identification Routines

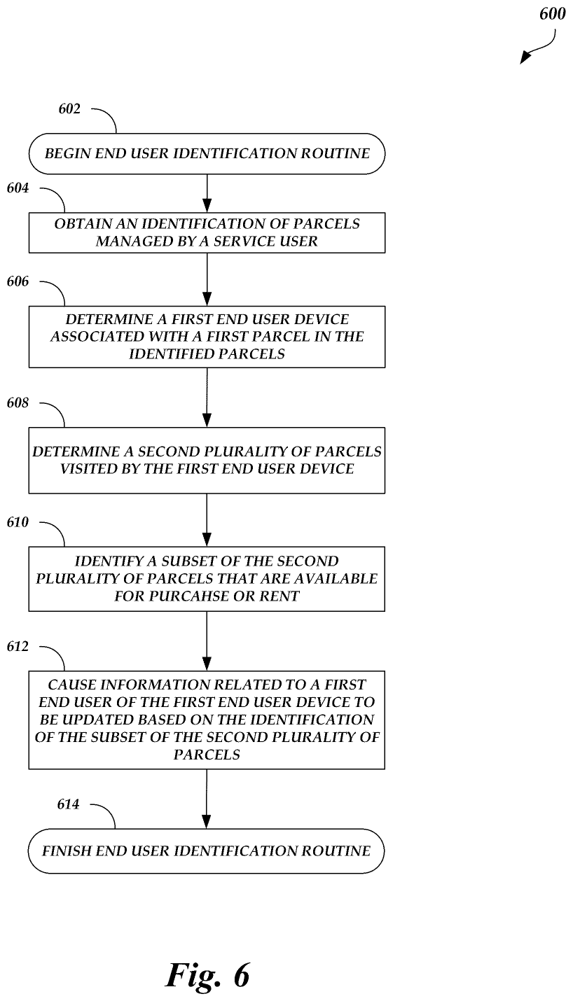

FIG. 6 is a flow diagram depicting an example end user identification routine 600 illustratively implemented by a user identification system and/or a user device mapping system, according to one embodiment. As an example, the user identification system 120 and/or the user device mapping system 130 of FIG. 1 can be configured to execute the end user identification routine 600. The end user identification routine 600 begins at block 602.

At block 604, an identification of parcels managed by a service user is obtained. For example, the parcels may be associated with end users who are customers or would-be customers of the service user.

At block 606, a first end user device is determined that is associated with a first parcel in the identified parcels. For example, the first end user device may spend a majority of time at the first parcel (and therefore the first end user device may be considered to reside at the first parcel).

At block 608, a second plurality of parcels visited by the first end user device is determined. For example, the second plurality of parcels may be parcels at which the first end user device does not reside, but at which the first end user device has visited one or more times and/or has visited for at least a threshold amount of time each visit.

At block 610, a subset of the second plurality of parcels that are available for purchase or rent is identified. For example, parcel data can be retrieved and parsed to identify parcels that are available on the market for sale or rent.

At block 612, information related to a first end user of the first end user device is caused to be updated based on the identification of the subset of the second plurality of parcels. For example, the information updated may be a portion of a CRM file associated with the first end user. The update can include any of the information described herein, including additional information, observations, etc. After the information is updated, the end user identification routine 600 ends, as shown at block 614.

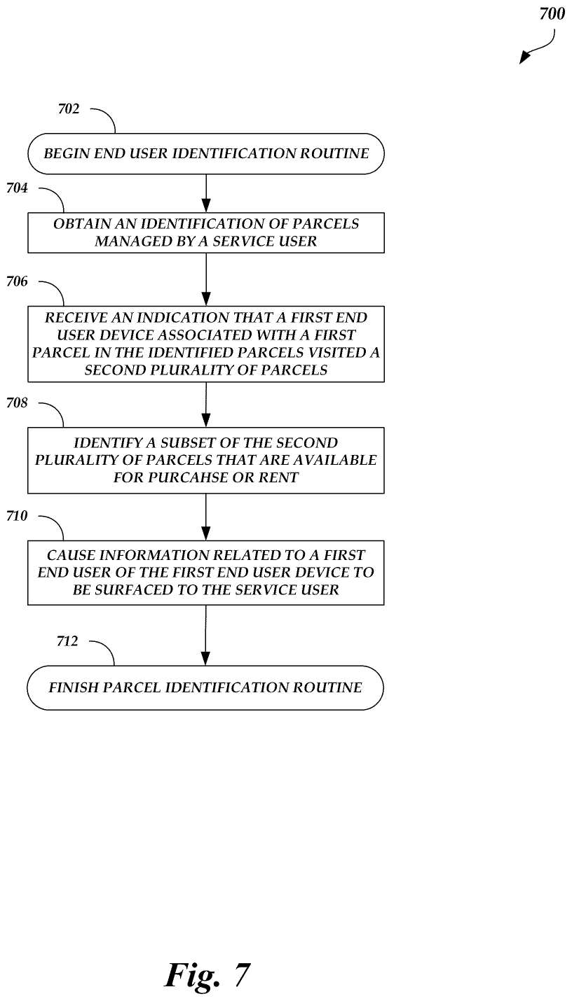

FIG. 7 is another flow diagram depicting an example end user identification routine 700 illustratively implemented by a user identification system, according to one embodiment. As an example, the user identification system 120 of FIG. 1 can be configured to execute the end user identification routine 700. The end user identification routine 700 begins at block 702.

At block 704, an identification of parcels managed by a service user is obtained. For example, the parcels may be associated with end users who are customers or would-be customers of the service user.

At block 706, an indication is received that a first end user device associated with a first parcel in the identified parcels visited a second plurality of parcels. For example, the first end user device may spend a majority of time at the first parcel (and therefore the first end user device may be considered to reside at the first parcel). The second plurality of parcels may be parcels at which the first end user device does not reside, but at which the first end user device has visited one or more times and/or has visited for at least a threshold amount of time each visit.

At block 708, a subset of the second plurality of parcels that are available for purchase or rent is identified. For example, parcel data can be retrieved and parsed to identify parcels that are available on the market for sale or rent.

At block 710, information related to a first end user of the first end user device is caused to be surfaced to the service user. For example, the information can be surfaced via an update to a CRM file, via a user interface, and/or the like. The information surfaced can include any of the information described herein, including additional information, observations, etc. After the information is surfaced, the end user identification routine 700 ends, as shown at block 712.

### Additional Embodiments

Various example user devices 102 are shown in FIG. 1, including a desktop computer, laptop, and a mobile phone, each provided by way of illustration. In general, the user devices 102 can be any computing device such as a desktop, laptop or tablet computer, personal computer, wearable computer, server, personal digital assistant (PDA), hybrid PDA/mobile phone, mobile phone, television, electronic book reader, set-top box, voice command device, camera, digital media player, and the like. A user device 102 may execute an application (e.g., a browser, a stand-alone application, etc.) that allows a service user to request and/or view a list of end users that may be interested in a product or service offered by the service user.

The network 110 may include any wired network, wireless network, or combination thereof. For example, the network 110 may be a personal area network, local area network, wide area network, over-the-air broadcast network (e.g., for radio or television), cable network, satellite network, cellular telephone network, or combination thereof. As a further example, the network 110 may be a publicly accessible network of linked networks, possibly operated by various distinct parties, such as the Internet. In some embodiments, the network 110 may be a private or semi-private network, such as a corporate or university intranet. The network 110 may include one or more wireless networks, such as a Global System for Mobile Communications (GSM) network, a Code Division Multiple Access (CDMA) network, a Long Term Evolution (LTE) network, or any other type of wireless network. The network 110 can use protocols and components for communicating via the Internet or any of the other aforementioned types of networks. For example, the protocols used by the network 110 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for identifying an end user that exhibits a type of behavior, the system comprising:
memory that stores computer-executable instructions; and
a processor in communication with the memory, wherein the computer-executable instructions, when executed by the processor, cause the processor to:
obtain an identification of a first plurality of parcels managed by a service user;
determine, using mobility data, a first end user device that is associated with a first parcel in the first plurality of parcels;
determine, using the mobility data, a second plurality of parcels visited by the first end user device;
identify a subset of the second plurality of parcels that each comprise a characteristic that corresponds with the type of behavior; and
cause information related to a first end user of the first end user device to be updated based on the identification of the subset of the second plurality of parcels.

2. The system of claim 1, wherein the computer-executable instructions, when executed, further cause the processor to:
obtain supplemental data that identifies an action performed by the first end user that corresponds with the type of behavior; and
cause information related to a first end user of the first end user device to be updated based on the identification of the subset of the second plurality of parcels and reception of the supplemental data that identifies the action performed by the first end user that corresponds with the type of behavior.

3. The system of claim 1, wherein the computer-executable instructions, when executed, further cause the processor to provide at least one of the mobility data associated with the first end user device or parcel data as an input to a trained artificial intelligence model, wherein providing at least one of the mobility data associated with the first end user device or the parcel data as the input to the trained artificial intelligence model causes the trained artificial intelligence model to output a propensity score that represents a likelihood that the first end user is engaging in an action that corresponds with the type of behavior.

4. The system of claim 3, wherein the computer-executable instructions, when executed, further cause the processor to cause the information related to the first end user of the first end user device to be updated with the propensity score.

5. The system of claim 1, wherein the computer-executable instructions, when executed, further cause the processor to mask personally identifiable information comprised within the mobility data.

6. The system of claim 1, wherein the computer-executable instructions, when executed, further cause the processor to:
generate user interface data that, when processed by a user device, causes the user device to render and display a user interface, wherein the user interface depicts the information related to the first end user and a geographic map identifying a location of the first parcel; and
transmit the user interface data to the user device.

7. The system of claim 6, wherein the user interface further comprises a filter, wherein selection of the filter causes the user interface to display the information related to the first end user in response to a determination that the first end user satisfies a criterion of the filter.

8. The system of claim 7, wherein the filter comprises one of a geography filter, a new end user filter, a low-to-moderate (LMI) income filter, an end user behavior filter, a contact status filter, or a service user team member assignment filter.

9. The system of claim 1, wherein the computer-executable instructions, when executed, further cause the processor to cause the information related to the first end user to be updated periodically.

10. The system of claim 1, wherein the computer-executable instructions, when executed, further cause the processor to transmit the information related to the first end user in response to an application programming interface (API) call.

11. The system of claim 1, wherein the computer-executable instructions, when executed, further cause the processor to include the information related to the first end user in a customer relationship management (CRM) file owned by the service user.

12. The system of claim 1, wherein the computer-executable instructions, when executed, further cause the processor to cause the first end user device to display a digital advertisement that describes a service offered by the service user.

13. The system of claim 12, wherein the first end user is an existing customer of the service user.

14. The system of claim 1, wherein the computer-executable instructions, when executed, further cause the processor to:
determine that the first end user device traveled to a first geographic location based on the mobility data;
determine based on the mobility data that the first end user device spent more time at the first geographic location than any other geographic location during a first time period;
determine that the first parcel is located at the first geographic location; and
map the first end user device to the first parcel.

15. The system of claim 1, wherein the characteristic comprises an availability for purchase or rent.

16. A computer-implemented method for identifying an end user that exhibits a type of behavior, the computer-implemented method comprising:
obtaining an identification of a first plurality of parcels managed by a service user;
determining, using mobility data, a first end user device that is associated with a first parcel in the first plurality of parcels;
determining, using the mobility data, a second plurality of parcels visited by the first end user device;
identifying a subset of the second plurality of parcels that each comprise a characteristic that corresponds with the type of behavior; and
causing information related to a first end user of the first end user device to be updated based on the identification of the subset of the second plurality of parcels.

17. The computer-implemented method of claim 16, further comprising providing at least one of the mobility data associated with the first end user device or parcel data as an input to a trained artificial intelligence model, wherein providing at least one of the mobility data associated with the first end user device or the parcel data as the input to the trained artificial intelligence model causes the trained artificial intelligence model to output a propensity score that represents a likelihood that the first end user is engaging in an action that corresponds with the type of behavior.

18. The computer-implemented method of claim 16, further comprising:
generating user interface data that, when processed by a user device, causes the user device to render and display a user interface, wherein the user interface depicts the information related to the first end user and a geographic map identifying a location of the first parcel; and
transmitting the user interface data to the user device.

19. The computer-implemented method of claim 18, wherein the user interface further comprises a filter, wherein selection of the filter causes the user interface to display the information related to the first end user in response to a determination that the first end user satisfies a criterion of the filter.

20. A non-transitory, computer-readable medium comprising computer-executable instructions for identifying an end user that exhibits a type of behavior, wherein the computer-executable instructions, when executed by a computer system, cause the computer system to:
obtain an identification of a first plurality of parcels managed by a service user;
determine, using mobility data, a first end user device that is associated with a first parcel in the first plurality of parcels;
determine, using the mobility data, a second plurality of parcels visited by the first end user device;
identify a subset of the second plurality of parcels that each comprise a characteristic that corresponds with the type of behavior; and
cause information related to a first end user of the first end user device to be updated based on the identification of the subset of the second plurality of parcels.
